(19) United States
(12) Patent Application Publication
(10) Pub. No.: US 2023/0306298 A1
(43) Pub. Date: Sep. 28, 2023

(54) COGNITIVE USABILITY TEST

(71) Applicant: International Business Machines Corporation, Armonk, NY (US)

(72) Inventors: Yue Dong, Ningbo (CN); Yu Zhu MX Xu, Ningbo (CN); Wei Yan, Ningbo (CN); Chao Dong, Ningbo (CN)

(21) Appl. No.: 17/701,902

(22) Filed: Mar. 23, 2022

(51) Int. Cl. G06N 20/00

(52) U.S. Cl. CPC G06N 20/00

(57) ABSTRACT

A system may include a memory and a processor in communication with the memory. The processor may be configured to perform operations. The operations may include training a cognitive engine and receiving a goal for the cognitive engine. The operations may include recognizing, with the cognitive engine, at least one actionable element and attempting, with the cognitive engine, operations on the at least one actionable element. The operations may include tracking data affiliated with the operations and generating, based on the data, a usability score for a user.

### BACKGROUND

The present disclosure relates to user experience and, more specifically, to usability of user interface.

Product usability is a measurement of how easily a user may accomplish a given task with a given product; usability measurement may include various metrics, for example, the effectiveness, efficiency, learnability, error prevention, and/or memorability of a product. Product usability is an important element of product development, promotion, and delivery. Usability is often tested and verified prior to product adoption, such as, e.g., before and/or during an early release of a product. Usability may be continually tested and/or improved upon throughout product development and/or implementation.

### SUMMARY

Embodiments of the present disclosure include a system, method, and computer program product for a cognitive usability test. A system in accordance with the present disclosure may include a memory and a processor in communication with the memory. The processor may be configured to perform operations. The operations may include training a cognitive engine and receiving a goal for the cognitive engine. The operations may include recognizing, with the cognitive engine, at least one actionable element and attempting, with the cognitive engine, operations on the at least one actionable element. The operations may include tracking data affiliated with the operations and generating, based on the data, a usability score for a user.

The above summary is not intended to describe each illustrated embodiment or every implement of the disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a cognitive usability test mechanism in accordance with some embodiments of the present disclosure.

FIG. 2 depicts a cognitive usability pre-testing phase in accordance with some embodiments of the present disclosure.

FIG. 3 illustrates a cognitive usability main testing phase in accordance with some embodiments of the present disclosure.

FIG. 4 depicts a cognitive usability post-testing phase in accordance with some embodiments of the present disclosure.

FIG. 5 illustrates a computer implemented method for a cognitive usability test in accordance with some embodiments of the present disclosure.

FIG. 6 illustrates a cloud computing environment, in accordance with embodiments of the present disclosure.

FIG. 7 depicts abstraction model layers, in accordance with embodiments of the present disclosure.

FIG. 8 illustrates a high-level block diagram of an example computer system that may be used in implementing one or more of the methods, tools, and modules, and any related functions, described herein, in accordance with embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to user experience and, more specifically, to usability of user interface.

User experience of a product may include, for example, satisfaction, enjoyment, pleasure, value, fun, and usability of the product. Aspects impacting user experience may be tested for a product, including the usability of the product. Product usability is a measurement of how easily a user may accomplish a given task with a given product; usability measurement may include various metrics, for example, the effectiveness, efficiency, learnability, error prevention, and/or memorability of a product. In some circumstances, product usability may be difficult to validate in a timely manner, it may be difficult to determine proper evaluation criteria, and/or it may be difficult to combine product usability testing with functional verification testing.

Usability for products may depend on user experience (UX) design. A validation approach for usability and UI may include collecting feedback via net promoter score (NPS) or user interview; such approaches may require a live product to collect feedback, potentially resulting in the loss of users prior to integration of any feedback. Additionally, certain design systems may be used for evaluation that may impact the usability of the tested product; for example, a design system that is difficult to use may make it difficult to test and evaluate new products, resulting in an inaccurately low usability rating for the tested product. Moreover, products are often tested with a functional verification test (FVT) rather than a formal usability test; such testing may be inordinately influenced by emotional state of the tester at the time of testing rather than an objective analysis of the product.

In accordance with some embodiments of the present disclosure, a cognitive computing-driven approach may be used to estimate and/or quantify the usability of products and/or features within an application.

The present disclosure discusses a cognitive-driven approach to testing usability in three phases: pre-testing, testing, and post-testing. A pre-testing phase may include training a cognitive engine with a standard and/or industry-specific knowledge rules and assigning cost scores to various operations. A testing phase may include assigning the trained cognitive engine a goal and tracking the operations of the cognitive engine as it attempts to complete the assigned goal. A post-testing phase may include identifying a usability score; in some embodiments, the post-testing phase may include providing one or more usability improvement suggestions.

In some embodiments of the present disclosure, the cognitive usability test may be used to process and validate products quickly such that the disclosure would enable additional time to refine product usability prior to release of the product. In some embodiments, the cognitive usability test may thus be used to minimize user turnover or similar loss by optimizing the user experience prior to user engagement.

In some embodiments of the present disclosure, a cognitive usability test may enable design experience sharing such that feedback and other data may be available across design languages and industries. In some embodiments, product validation and usability scores may be made quantifiable, reason-based, accurate, precise, and/or score-specific. Such a testing result may provide data input such as to inform one or more designers when the designers are using the same or a similar system for another project, product, or client. Similarly, the information may be used in the development of other projects, products, systems, applications, or similar.

In some embodiments of the present disclosure, a cognitive usability test may be used to reduce strain on human resources regarding testing usability for a project, product, system, application, or similar; for example, cognitive usability testing may be employed for automatic execution to reduce the efforts necessary in testing. Cognitive engines may be trained such that they may be easily reused for multiple applications. Cognitive engines may be trained such that they may be deployed for use across a whole project. A testing script may be processed automatically and used and/or re-used such that human work hours spent during testing may be minimized, enabling project efficiency.

In some embodiments of the present disclosure, a cognitive usability test may enable a tool to provide common criteria and quantitative scoring, thereby reducing the impact of non-quantifiable criteria. In some embodiments, the present disclosure may increase the reasonability of results and/or the ability to quantifiably evaluate the results.

In some embodiments, the present disclosure may enable automatic testing of usability using a cognitive engine. In some embodiments, the cognitive engine may be trained so as to capture and simulate the full human experience such that any costs (e.g., clicks, movements, delays, and the like) may be tracked and reflected in a usability score. In some embodiments, the cognitive usability engine will identify quantitative reasons for whether a case execution path is a good usability case and/or potential usability improvements that could be made.

In some embodiments, the present disclosure may enable analysis of one or more test results regarding the execution sequence. In some embodiments, the cognitive engine may identify an ideal user interaction or behavior for the product being tested instead of or in addition to an ideal user interface design and/or display. In some embodiments of the present disclosure, the cognitive engine may utilize a mechanism of self-improvement.

Some embodiments of the present disclosure may enable generating dynamic test cases using a semantic similarity algorithm. In some embodiments of the present disclosure, a test case may be generated automatically. In some embodiments, a cognitive engine may automatically generate test cases. Some embodiments of the present disclosure may analyze one or more test results of an execution sequence; such an analysis may provide insight concerning the usability of a product and/or insight regarding improving the usability of the product.

In some embodiments of the present disclosure, a case execution path may be tested to identify to usability of the case execution path. In some embodiments, the behavior of test results may be analyzed to identify usability. In some embodiments of the disclosure, an intelligent case execution process may be used. Use of an intelligent case execution may result in requiring less testing to achieve a desired result. Thus, use of an intelligent case execution process may enable economical use of computing resources for obtaining data. Use of an intelligent case execution may be particularly useful for gathering information concerning complex applications.

In some embodiments of the present disclosure, one or more recommendations for improvement of usability for a user may be provided. Some embodiments of the present disclosure may include recommendations for improving user usability of a product. In some embodiments of the present disclosure, a self-improvement mechanism may be included such that, for example, a test may be run on several applications and the cognitive engine and/or results/analyses therefrom improves with each iteration. Some embodiments of the present disclosure may determine an ideal interaction mechanism and/or optimized user interface (UI).

Some embodiments of the present disclosure may provide a self-improving mechanism of the testing approach. As such, testing may be harvested and applied to other applications, including applications with the same domain.

A system in accordance with the present disclosure may include a memory and a processor in communication with the memory. The processor may be configured to perform operations. The operations may include training a cognitive engine and receiving a goal for the cognitive engine. The operations may include recognizing, with the cognitive engine, at least one actionable element and attempting, with the cognitive engine, operations on the at least one actionable element. The operations may include tracking data affiliated with the operations and generating, based on the data, a usability score for a user.

In some embodiments of the present disclosure, the operations may include achieving the goal via the operations to in an operation sequence. In some embodiments, the operations may further include setting a cost score for each of the operations in the operation sequence. In some embodiments, the operations may further include summing the cost score for each the operations in the operation sequence.

In some embodiments of the present disclosure, the operations may include determining at least one suggestion to improve the usability score. In some embodiments, the operations may further include providing the at least one suggestion to the user. In some embodiments, the user may be a developer and/or UX designer.

In some embodiments of the present disclosure, the operations may include generating a dynamic test case by the cognitive engine. In some embodiments, the operations may further include using a semantic similarity algorithm to generate the dynamic test case.

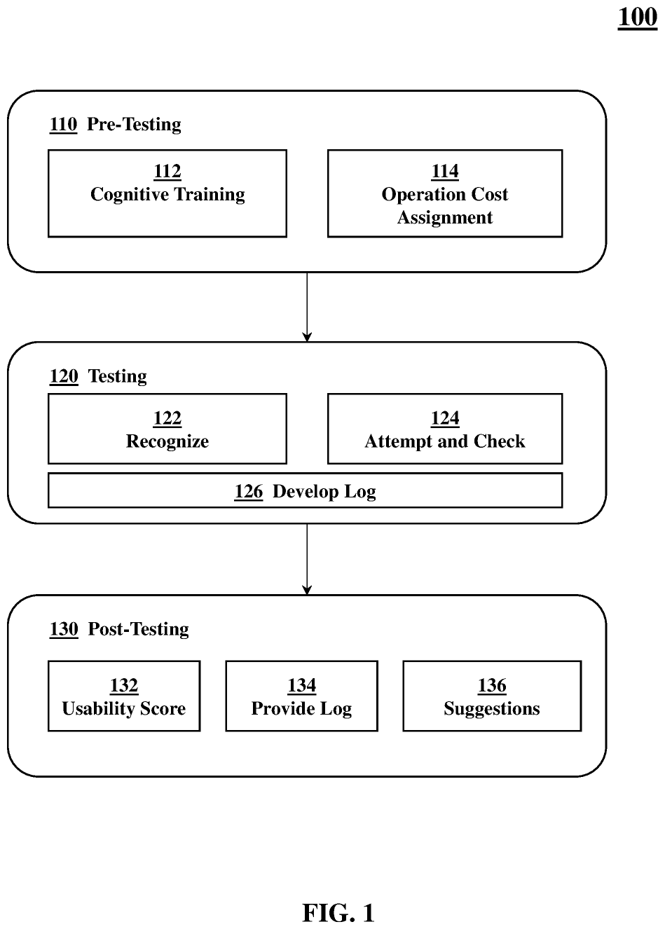

FIG. 1 illustrates a cognitive usability test mechanism 100 in accordance with some embodiments of the present disclosure. The cognitive usability test mechanism 100 includes a pre-testing phase 110, a testing phase 120, and a post-testing phase 130.

The pre-testing phase 110 may include training 112 a cognitive engine. Training 112 the cognitive engine may include using a standard knowledge database and/or an industry-specific knowledge database. The training 112 may enable, or increase the ability of, the cognitive engine to recognize images and/or words used in an application. The pre-testing phase 110 may include assigning 114 cost scores to various operations. The operation cost scores may be predefined according to an operation cost dictionary, manually entered, or some combination thereof. In some embodiments, a predefined operation cost dictionary may be used for operation cost assignment.

The testing phase 120 may include assigning the trained cognitive engine a goal and tracking the operations of the cognitive engine as it attempts to complete the assigned goal. The testing phase 120 may thus include the cognitive engine recognizing 122 the goal and the actionable elements on the application the goal is assigned for. The cognitive engine may then attempt and check 124 one or more operations to achieve the goal. The cognitive engine may attempt and check 124 operations based on the semantic similarity between the available operations and the assigned goal. The testing phase 120 may include tracking data of the operations taken by the cognitive engine in a log 126 to identify and total operational cost scores. Operational cost scores of actions within a sequence taken to achieve the assigned goal may be summed to identify an operational cost score of the sequence. Operations, operational cost scores, and operational sequence cost sums may be maintained in the log 126.

The post-testing phase 130 may include usability score 132 population; the usability score 132 may have been obtained during the testing phase 120 via the log 126 of the operations and operational scores. The post-testing phase may include providing the log 134 of the operations taken by the cognitive engine during the testing phase 120 to a database and/or user. The post-testing phase 130 may include one or more suggestions 136 for usability improvement being tracked and/or provided to a log file or user. Usability improvement suggestions 136 may be, for example, any modification or change to the existing program or application to result in a better usability score (e.g., a lower operation cost which would thereby result in a lower usability score).

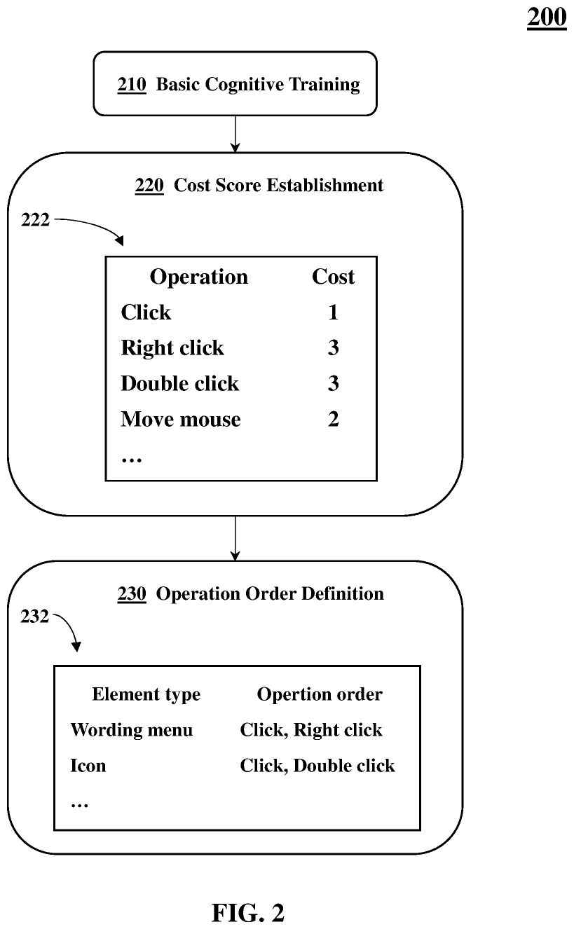

FIG. 2 depicts a cognitive usability pre-testing phase 200 of a cognitive usability test (e.g., the cognitive usability test 100 of FIG. 1) in accordance with some embodiments of the present disclosure. The cognitive usability pre-testing phase 200 may include basic cognitive training 210, cost score establishment 220, and operation order definition 230.

A cognitive engine may be trained with basic cognitive training 210 during a cognitive usability pre-testing phase 200. The basic cognitive training 210 of the cognitive engine may include using a standard knowledge training data and/or an industry-specific knowledge training data. The basic cognitive training 210 may enable or increase the ability of the cognitive engine to recognize images and/or words used in an application or program such that the cognitive engine may engage with the application or program. The basic cognitive training 210 may enable or assist the cognitive engine to engage with the program or application in such a way as to replicate how a natural human person would engage with the program or application.

The cognitive usability pre-testing phase 200 may include cost score establishment 220 for one or more operations. The cost score establishment 220 may establish, set, or otherwise affiliate a cost score with each operation or action a cognitive engine may engage in. The cost scores of the various operations and/or actions may be tracked in a cost score table 222.

The cognitive usability pre-testing phase 200 of a cognitive usability test may include operation order definition 230. The operation order definition 230 may identify the operations or actions associated with each type of element that is or may be available for a cognitive engine to engage with. Element types may include, for example, words, word menus, icons, icon menus, videos, video menus, and the like. A word element type may be, for example, the word “mute” or “microphone” on a screen. An icon element may be, for example, a picture of a microphone with a slash through it. A video element may be, for example, an animation of crossing out a microphone. Element types may be used together; for example, an icon may be used for displaying a menu of words, a word may be used for displaying a menu of icons and videos, a video may be used for displaying a menu of words, icons, and videos, or some other combination may be used.

Operations may include moving a cursor, clicking (e.g., right clicking or left clicking), combination clicking (e.g., right double-clicking, left double-clicking, right-clicking then left-clicking, or another ordered multi-clicking), and the like. Some operations, such as moving a cursor, may have more than one cost score options depending on the extent of the action; for example, moving a cursor slightly may incur an operation cost of one whereas moving a cursor across a screen may incur an operation cost of three. The operations or actions associated with each element type may be tracked such as, for example, in an element to operation table 232.

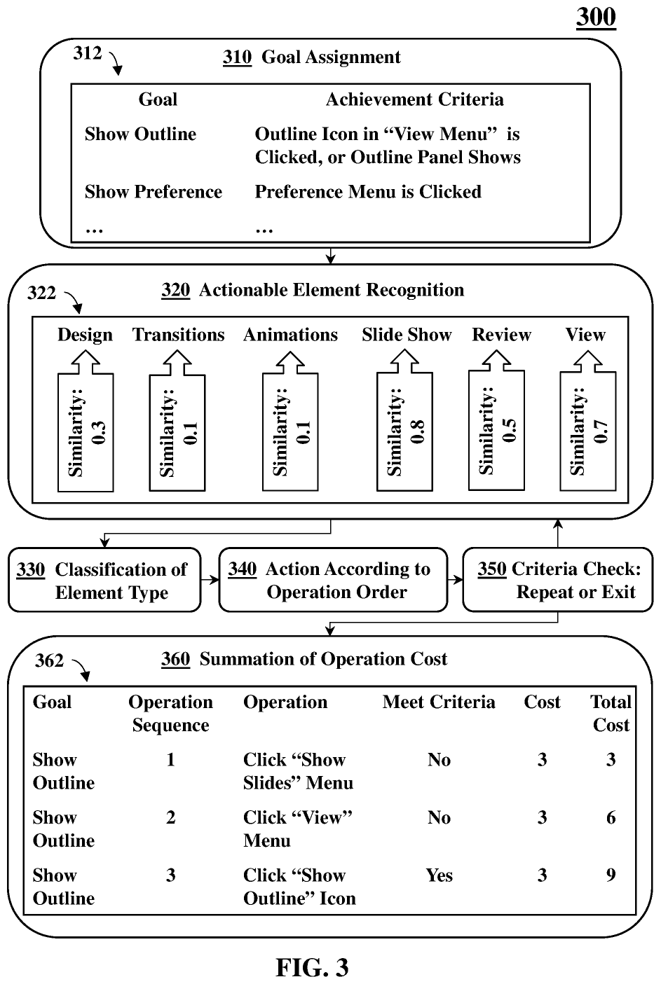

FIG. 3 illustrates a cognitive usability testing phase 300 of a cognitive usability test (e.g., the cognitive usability test 100 of FIG. 1) in accordance with some embodiments of the present disclosure. The cognitive usability testing phase 300 may include goal assignment 310, actionable element recognition 320, classifying 330 per element type(s), acting 340 according to an operation order, checking 350 criteria, and summation 360 of an operation sequence cost.

A cognitive engine may engage in testing of a product. The cognitive engine may engage in the cognitive usability testing phase 300 upon goal assignment 310. The goal assignment 310 may include a goal and the criteria necessary for achieving the goal. The criteria may include, for example, sending an application programming interface (API), clicking a certain button, selecting a specific item, showing a particular image, and the like. A goal assignment 310 may include one or more goals such as, for example, showing an outline, identifying a preference, loading a document, or launching a presentation. The goals may have various criteria such as the goals and criteria delineated in a goal criteria table 312.

The cognitive engine may engage in actionable element recognition 320 as part of the testing phase 300. The cognitive engine may recognize all available actionable elements in the product, program, or application being tested. Based on the received training (e.g., pre-testing phase 200 shown in FIG. 2), the cognitive engine may understand semantic similarities between the enumerated goal(s) received in the goal assignment 310. In some embodiments, the cognitive engine may rank actionable elements in order of similarity. The cognitive engine may select and perform the actionable element with the greatest degree of similarity. Actionable elements may be identified and tracked as part of actionable element recognition 320. In some embodiments, the actionable elements and the similarity of each actionable element may be identified 322 and tracked in an element similarity table.

In some embodiments, the cognitive engine may engage in element selection using an optimization algorithm such as a greedy algorithm; in some embodiments, other algorithms or mechanisms may be used alternatively or in conjunction with the optimization algorithm.

The cognitive engine may perform classifying 330 based on element type(s). The cognitive engine may classify each element to an element type. Element classifications may include, for example, words, icons, videos, menus, or some combination thereof. In some embodiments, multiple layers of element classification may be used; for example, an actionable element may be classified separately as both an icon and a menu. In some embodiments, one layer of classifications may be used; for example, an actionable element may be classified as an icon-and-menu, an icon, or a menu such that the log (e.g., the log 126 developed during the testing phase 120 shown in FIG. 1) maintains three separate classifications.

The cognitive engine may engage in acting 340 according to an operation order (such as the operation order definition 230 identified in FIG. 2). Such actions may include, for example, moving a cursor, clicking, and/or combination clicking.

The cognitive engine may engage in the testing phase 300 by criteria checking 350 after performing each action. Checking 350 criteria may be a mechanism for the cognitive engine to determine whether the target identified in the goal assignment 310 was achieved. If the target identified in the goal assignment 310 was not achieved, the cognitive engine may loop back to actionable element recognition 320 to attempt another action which may achieve the target identified in the goal assignment 310.

In some embodiments, the cognitive engine may loop to classifying 330 or acting 340. In some embodiments, the cognitive engine may continue to loop back through the testing phase 300 multiple times to achieve the goal and/or optimize the result. In some embodiments, the cognitive engine may repeatedly loop back to the same operation; in some embodiments, the cognitive engine may loop back to a combination of operations. If the target identified in the goal assignment 310 was achieved, the cognitive engine may exit the loop and proceed to summation 360.

The cognitive engine may engage in the summation 360 of an operation sequence cost. The summation 360 may include affiliating one or more goals with the one or more operation sequences the cognitive engine took to achieve the goal. The summation 360 may include identifying the operations taken for each sequence, whether each operation sequence met the criteria of the affiliated goal, the cost of each operation in a sequence, the total cost of the operation sequence, and similar information. Summation 360 may include summing all of the operation costs for an undertaken sequence to arrive at a total sequence cost for the operations necessary to achieve the goal assigned during goal assignment 310. Information tracked for the summation 360 of the operation cost may be tracked, for example, in an operation cost table 362.

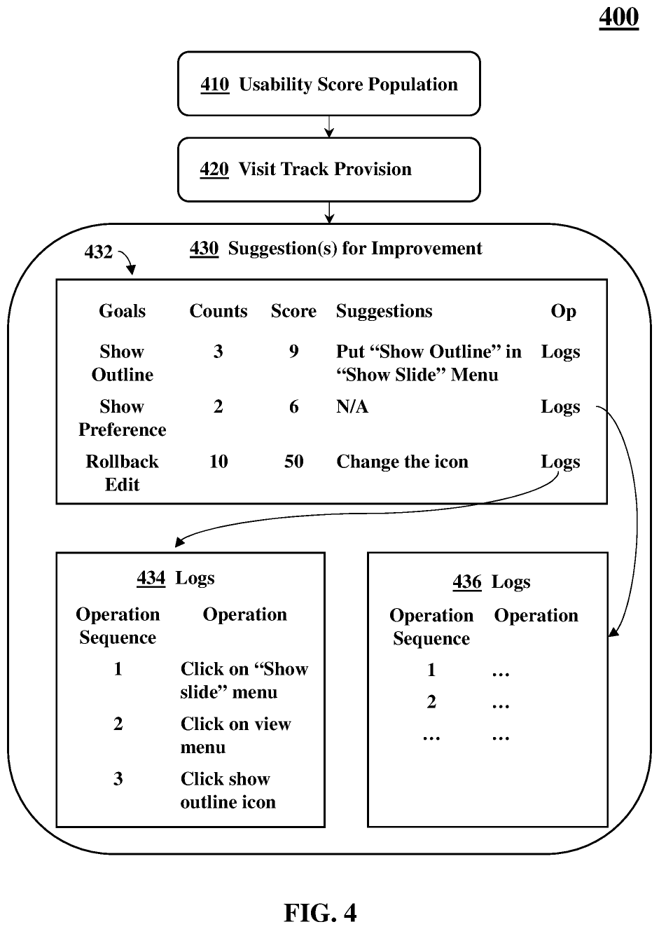

FIG. 4 depicts a cognitive usability post-testing phase 400 of a cognitive usability test (e.g., the cognitive usability test 100 of FIG. 1) in accordance with some embodiments of the present disclosure. The cognitive usability post-testing phase 400 may include usability score population 410, visit track provision 420, and suggestion(s) for improvement 430.

Usability score population 410 may include compiling operation sequence costs (e.g., from an operation cost table 362 assembled during a summation 360 of operation costs as indicated in FIG. 3) and using such costs to compute one or more usability scores. The usability scores may be populated, for example, to a usability score table, list, or other mechanism for notifying a user of one or more usability scores.

Visit track provision 420 may include data regarding operations and actions undertaken by the cognitive engine. In some embodiments, a full schedule of actions taken may be made available for the visit track provision 420. The visit track information may be made available to a user via any mechanism known in the art or hereinafter developed such as, for example, a table of actions taken, a list, a playback, a highlight reel, or other notification instrument.

The suggestion(s) for improvement 430, if provided, may include one or more recommendations for refining user experience. The suggestion(s) for improvement 430 may include, for example, a suggestions table 432 that includes suggestions for one or more goals and/or data regarding the assigned goal, the usability score associated with the goal, an expected change in the usability score, one or more suggestions for the particular goal, and/or an operation log or links to an operation log 434 or 436. Suggestion(s) made may be offered via any mechanism known in the art or hereinafter developed such as a suggestions table 432, a list, an explanation of suggestion implementation, and the like. The operation logs 434 and 436 may be embedded into the suggestions table 432, open separately, or be otherwise made available to a developer/UX designer.

A method in accordance with the present disclosure may include training a cognitive engine and receiving a goal for the cognitive engine. The method may include recognizing, with the cognitive engine, at least one actionable element and attempting, with the cognitive engine, operations on the at least one actionable element. The method may include tracking data affiliated with the operations and generating, based on the data, a usability score for a user.

In some embodiments of the present disclosure, the method may include achieving the goal via the operations to in an operation sequence. In some embodiments, the method may further include setting a cost score for each of the operations in the operation sequence. In some embodiments, the method may further include summing the cost score for each the operations in the operation sequence.

In some embodiments of the present disclosure, the method may include determining at least one suggestion to improve the usability score. In some embodiments, the method may further include providing the at least one suggestion to the developer/UX designer.

In some embodiments of the present disclosure, the method may include generating a dynamic test case by the cognitive engine. In some embodiments, the method may further include using a semantic similarity algorithm to generate the dynamic test case.

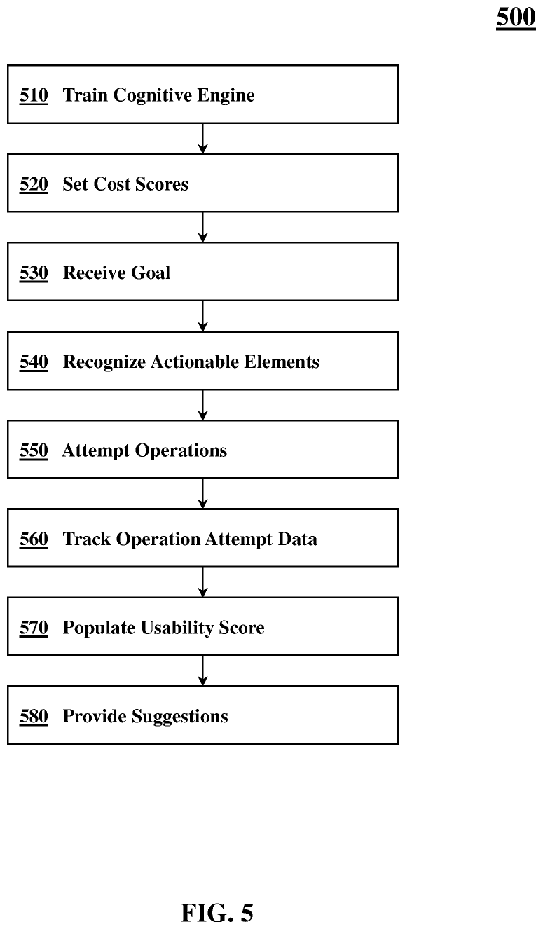

FIG. 5 illustrates a computer implemented method 500 for a cognitive usability test (such as the cognitive usability test mechanism 100 shown in FIG. 1) in accordance with some embodiments of the present disclosure. The method 500 includes training 510 a cognitive engine, setting 520 cost scores, receiving 530 a goal, recognizing 540 actionable elements, attempting 550 operations, tracking 560 operation attempt data, populating 570 a usability score, and providing 580 suggestions. Suggestions may include, for example, recommended changes to the design, interface, or other part of the user experience to improve the usability score.

In some embodiments of the present disclosure, phase designations may not be used. In some embodiments, the computer implemented method 500 operations may be designated into one or more phase designations; for example, training 510 and setting 520 cost scores may be designated as being performed during a pre-testing phase (e.g., cognitive usability pre-testing phase 200 of FIG. 2) whereas receiving 530 a goal, recognizing 540 actionable elements, attempting 550 operations, and tracking 560 operation attempt data are designated as being performed during a testing phase (e.g., cognitive usability testing phase 300 of FIG. 3), and whereas populating 570 a usability score and providing 580 suggestions are designated as being performed during a post-testing phase (e.g., cognitive usability post-testing phase 400 of FIG. 4).

In some embodiments of the present disclosure, operations within a certain phase designation may be implemented simultaneously or in an order that differs from that shown. For example, the operations of the computer implemented method 500 that are designated as part of a pre-testing phase may all be performed simultaneously, operations that are designated as part of a testing phase may all occur after the pre-testing phase in any order, and operations that are designated as part of the post-testing phase may occur simultaneously after the testing phase.

A computer program product in accordance with the present disclosure may include a computer readable storage medium having program instructions embodied therewith, the program instructions executable by a processor to cause the processor to perform a function. The function may include training a cognitive engine and receiving a goal for the cognitive engine. The function may include recognizing, with the cognitive engine, at least one actionable element and attempting, with the cognitive engine, operations on the at least one actionable element. The function may include tracking data affiliated with the operations and generating, based on the data, a usability score. In some embodiments, the function may include providing said usability score to a user.

In some embodiments of the present disclosure, the function may include achieving the goal via the operations to in an operation sequence. In some embodiments, the function may further include setting a cost score for each of the operations in the operation sequence. In some embodiments, the function may further include summing the cost score for each the operations in the operation sequence.

In some embodiments of the present disclosure, the function may include determining at least one suggestion to improve the usability score. In some embodiments, the function may further include providing the at least one suggestion to the user.

In some embodiments of the present disclosure, the function may include generating a dynamic test case by the cognitive engine. In some embodiments, the function may further include using a semantic similarity algorithm to generate the dynamic test case.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment currently known or that which may be later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly release to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but the consumer has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software which may include operating systems and applications. The consumer does not manage or control the underlying cloud infrastructure but has control over operating systems, storage, and deployed applications, and the consumer possibly has limited control of select networking components (e.g., host firewalls).

Deployment models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and/or compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

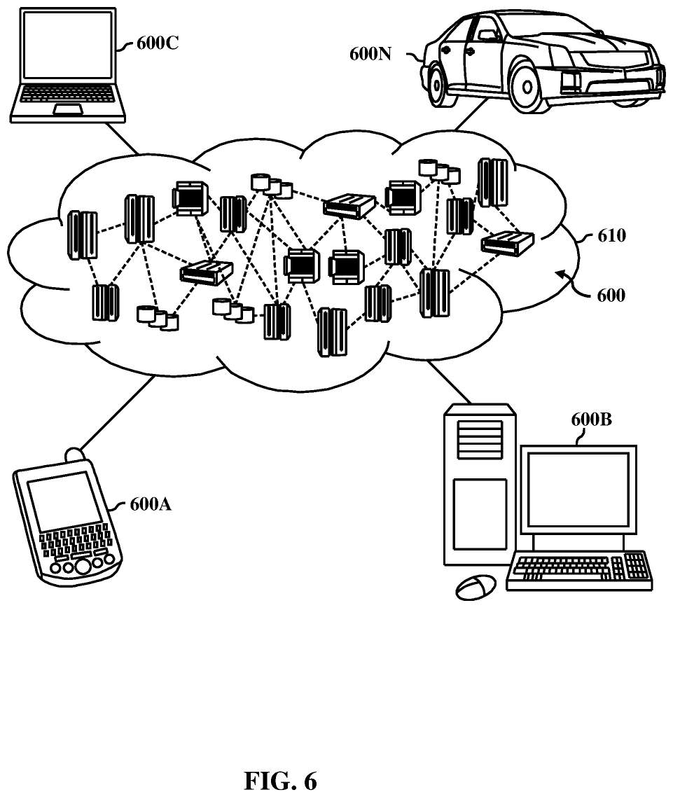

FIG. 6 illustrates a cloud computing environment 610 in accordance with embodiments of the present disclosure. As shown, cloud computing environment 610 includes one or more cloud computing nodes 600 with which local computing devices used by cloud consumers such as, for example, personal digital assistant (PDA) or cellular telephone 600A, desktop computer 600B, laptop computer 600C, and/or automobile computer system 600N may communicate. Nodes 600 may communicate with one another. They may be grouped (not shown) physically or virtually, in one or more networks, such as private, community, public, or hybrid clouds as described hereinabove, or a combination thereof.

This allows cloud computing environment 610 to offer infrastructure, platforms, and/or software as services for which a cloud consumer does not need to maintain resources on a local computing device. It is understood that the types of computing devices 600A-N shown in FIG. 6 are intended to be illustrative only and that computing nodes 600 and cloud computing environment 610 can communicate with any type of computerized device over any type of network and/or network addressable connection (e.g., using a web browser).

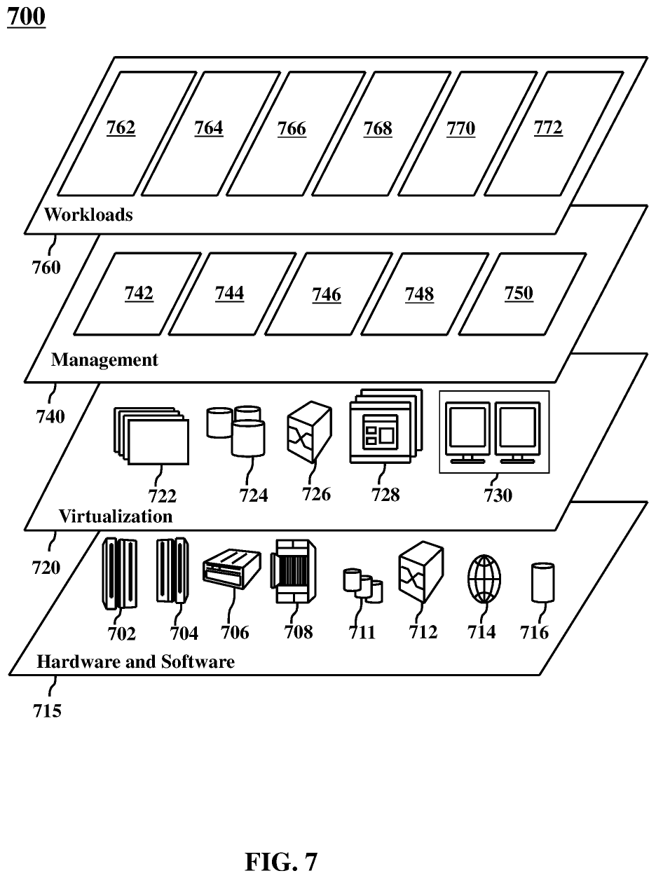

FIG. 7 illustrates abstraction model layers 700 provided by cloud computing environment 610 (FIG. 6) in accordance with embodiments of the present disclosure. It should be understood in advance that the components, layers, and functions shown in FIG. 7 are intended to be illustrative only and embodiments of the disclosure are not limited thereto. As depicted below, the following layers and corresponding functions are provided.

Hardware and software layer 715 includes hardware and software components. Examples of hardware components include: mainframes 702; RISC (Reduced Instruction Set Computer) architecture-based servers 704; servers 706; blade servers 708; storage devices 711; and networks and networking components 712. In some embodiments, software components include network application server software 714 and database software 716.

Virtualization layer 720 provides an abstraction layer from which the following examples of virtual entities may be provided: virtual servers 722; virtual storage 724; virtual networks 726, including virtual private networks; virtual applications and operating systems 728; and virtual clients 730.

In one example, management layer 740 may provide the functions described below. Resource provisioning 742 provides dynamic procurement of computing resources and other resources that are utilized to perform tasks within the cloud computing environment. Metering and pricing 744 provide cost tracking as resources and are utilized within the cloud computing environment as well as billing or invoicing for consumption of these resources. In one example, these resources may include application software licenses. Security provides identity verification for cloud consumers and tasks as well as protection for data and other resources. User portal 746 provides access to the cloud computing environment for consumers and system administrators. Service level management 748 provides cloud computing resource allocation and management such that required service levels are met. Service level agreement (SLA) planning and fulfillment 750 provide pre-arrangement for, and procurement of, cloud computing resources for which a future requirement is anticipated in accordance with an SLA.

Workloads layer 760 provides examples of functionality for which the cloud computing environment may be utilized. Examples of workloads and functions which may be provided from this layer include: mapping and navigation 762; software development and lifecycle management 764; virtual classroom education delivery 766; data analytics processing 768; transaction processing 770; and cognitive usability testing 772.

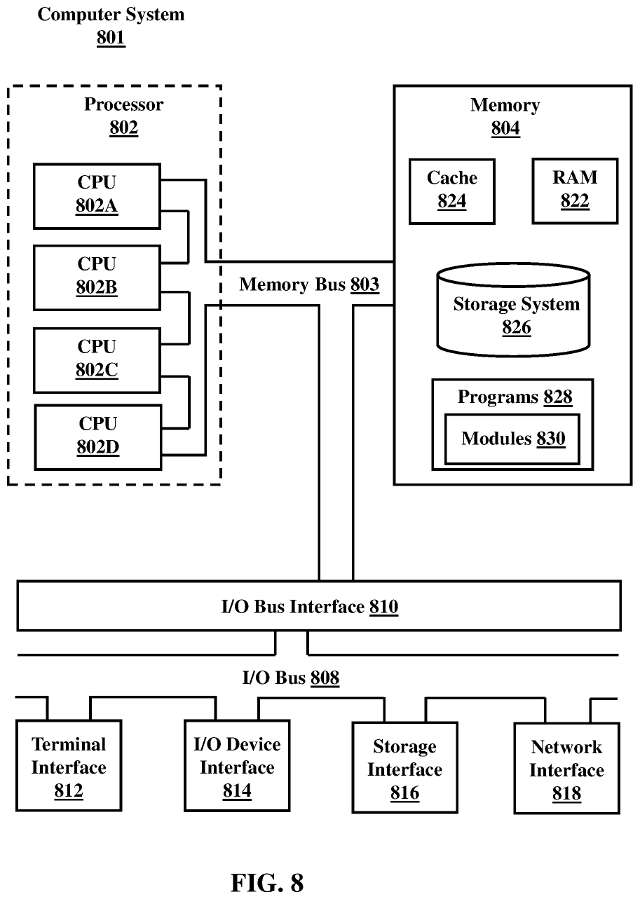

FIG. 8 illustrates a high-level block diagram of an example computer system 801 that may be used in implementing one or more of the methods, tools, and modules, and any related functions, described herein (e.g., using one or more processor circuits or computer processors of the computer) in accordance with embodiments of the present disclosure. In some embodiments, the major components of the computer system 801 may comprise a processor 802 with one or more central processing units (CPUs) 802A, 802B, 802C, and 802D, a memory subsystem 804, a terminal interface 812, a storage interface 816, an I/O (Input/Output) device interface 814, and a network interface 818, all of which may be communicatively coupled, directly or indirectly, for inter-component communication via a memory bus 803, an I/O bus 808, and an I/O bus interface unit 810.

The computer system 801 may contain one or more general-purpose programmable CPUs 802A, 802B, 802C, and 802D, herein generically referred to as the CPU 802. In some embodiments, the computer system 801 may contain multiple processors typical of a relatively large system; however, in other embodiments, the computer system 801 may alternatively be a single CPU system. Each CPU 802 may execute instructions stored in the memory subsystem 804 and may include one or more levels of on-board cache.

System memory 804 may include computer system readable media in the form of volatile memory, such as random access memory (RAM) 822 or cache memory 824. Computer system 801 may further include other removable/non-removable, volatile/non-volatile computer system storage media. By way of example only, storage system 826 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM, or other optical media can be provided. In addition, memory 804 can include flash memory, e.g., a flash memory stick drive or a flash drive. Memory devices can be connected to memory bus 803 by one or more data media interfaces. The memory 804 may include at least one program product having a set (e.g., at least one) of program modules that are configured to carry out the functions of various embodiments.

One or more programs/utilities 828, each having at least one set of program modules 830, may be stored in memory 804. The programs/utilities 828 may include a hypervisor (also referred to as a virtual machine monitor), one or more operating systems, one or more application programs, other program modules, and program data. Each of the operating systems, one or more application programs, other program modules, and program data, or some combination thereof, may include an implementation of a networking environment. Programs 828 and/or program modules 830 generally perform the functions or methodologies of various embodiments.

Although the memory bus 803 is shown in FIG. 8 as a single bus structure providing a direct communication path among the CPUs 802, the memory subsystem 804, and the I/O bus interface 810, the memory bus 803 may, in some embodiments, include multiple different buses or communication paths, which may be arranged in any of various forms, such as point-to-point links in hierarchical, star, or web configurations, multiple hierarchical buses, parallel and redundant paths, or any other appropriate type of configuration. Furthermore, while the I/O bus interface 810 and the I/O bus 808 are shown as single respective units, the computer system 801 may, in some embodiments, contain multiple I/O bus interface units 810, multiple I/O buses 808, or both. Further, while multiple I/O interface units 810 are shown, which separate the I/O bus 808 from various communications paths running to the various I/O devices, in other embodiments some or all of the I/O devices may be connected directly to one or more system I/O buses 808.

In some embodiments, the computer system 801 may be a multi-user mainframe computer system, a single-user system, a server computer, or similar device that has little or no direct user interface but receives requests from other computer systems (clients). Further, in some embodiments, the computer system 801 may be implemented as a desktop computer, portable computer, laptop or notebook computer, tablet computer, pocket computer, telephone, smartphone, network switches or routers, or any other appropriate type of electronic device.

It is noted that FIG. 8 is intended to depict the representative major components of an exemplary computer system 801. In some embodiments, however, individual components may have greater or lesser complexity than as represented in FIG. 8, components other than or in addition to those shown in FIG. 8 may be present, and the number, type, and configuration of such components may vary.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide, or other transmission media (e.g., light pulses passing through a fiber-optic cable) or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN) or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although the present disclosure has been described in terms of specific embodiments, it is anticipated that alterations and modifications thereof will become apparent to the skilled in the art. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or the technical improvement over technologies found in the marketplace or to enable others of ordinary skill in the art to understand the embodiments disclosed herein. Therefore, it is intended that the following claims be interpreted as covering all such alterations and modifications as fall within the true spirit and scope of the disclosure.

What is claimed is:

1. A system, said system comprising:
a memory; and
a processor in communication with said memory, said processor being configured to perform operations, said operations comprising:
training a cognitive engine;
receiving a goal for said cognitive engine;
recognizing, with said cognitive engine, at least one actionable element;
attempting, with said cognitive engine, operations on said at least one actionable element;
tracking data affiliated with said operations; and
generating, based on said data, a usability score for a user.

2. The system of claim 1, said operations further comprising:
achieving said goal via said operations to in an operation sequence.

3. The system of claim 2, said operations further comprising:
setting a cost score for each of said operations in said operation sequence.

4. The system of claim 3, said operations further comprising:
summing said cost score for each said operations in said operation sequence.

5. The system of claim 1, said operations further comprising:
determining at least one suggestion to improve said usability score.

6. The system of claim 1, said operations further comprising:
generating a dynamic test case by said cognitive engine.

7. The system of claim 6, said operations further comprising:
using a semantic similarity algorithm to generate said dynamic test case.

8. A method, said method comprising:
training a cognitive engine;
receiving a goal for said cognitive engine;
recognizing, with said cognitive engine, at least one actionable element;
attempting, with said cognitive engine, operations on said at least one actionable element;
tracking data affiliated with said operations; and
generating, based on said data, a usability score for a user.

9. The method of claim 8, further comprising:
achieving said goal via said operations to in an operation sequence.

10. The method of claim 9, further comprising:
setting a cost score for each of said operations in said operation sequence.

11. The method of claim 10, further comprising:
summing said cost score for each said operations in said operation sequence.

12. The method of claim 8, further comprising:
determining at least one suggestion to improve said usability score.

13. The method of claim 12, further comprising:
providing said at least one suggestion to said user.

14. The method of claim 8, further comprising:
generating a dynamic test case by said cognitive engine.

15. The method of claim 14, further comprising:
using a semantic similarity algorithm to generate said dynamic test case.

16. A computer program product, said computer program product comprising a computer readable storage medium having program instructions embodied therewith, said program instructions executable by a processor to cause said processor to perform a function, said function comprising:
training a cognitive engine;
receiving a goal for said cognitive engine;
recognizing, with said cognitive engine, at least one actionable element;
attempting, with said cognitive engine, operations on said at least one actionable element;
tracking data affiliated with said operations; and
generating, based on said data, a usability score for a user.

17. The computer program product of claim 16, further comprising:
achieving said goal via said operations to in an operation sequence.

18. The computer program product of claim 16, further comprising:
determining at least one suggestion to improve said usability score.

19. The computer program product of claim 16, further comprising:
generating a dynamic test case by said cognitive engine.

20. The computer program product of claim 19, further comprising:
using a semantic similarity algorithm to generate said dynamic test case.
